(19) United States
(12) Patent Application Publication
(10) Pub. No.: US 2021/0342769 A1
(43) Pub. Date: Nov. 4, 2021

(54) CONSUMABLE WASTE IDENTIFICATION

(71) Applicant: Hewlett-Packard Development Company, L.P., Spring, TX (US)

(72) Inventors: Dean H. Ouchida, Vancouver, WA (US); Armando Ugarte, Vancouver, WA (US)

(73) Assignee: Hewlett-Packard Development Company, L.P., Spring, TX (US)

(21) Appl. No.: 17/257,952

(22) PCT Filed: Jan. 10, 2019
(86) PCT No.: PCT/US2019/012971

§ 371 Date: Jan. 5, 2021

(51) Int. Cl. G06Q 10/08

(52) U.S. Cl. CPC G06Q 10/083

(57) ABSTRACT

Examples disclosed herein relate to creating a shipment order comprising a first consumable of a consumable type, calculating an expected waste cost for a second consumable of the consumable type, determining whether a shipping cost for the second consumable exceeds the expected waste cost, and in response to determining that the shipping cost exceeds the expected waste cost, adding the second consumable to the shipment order.

### BACKGROUND

Multi-function devices often combine different components such as a printer, scanner, and copier into a single device. Such devices frequently receive refills of consumables, such as print substances (e.g., ink, toner, and/or additive materials) and/or media (e.g., paper, vinyl, and/or other print substrates).

### BRIEF DESCRIPTION OF THE DRAWINGS

FIG. 1 is a block diagram of an example computing device for providing consumable waste identification.

FIG. 2 is a block diagram of n example system for providing consumable waste identification.

FIG. 3 is a flowchart of an example method for providing consumable waste identification.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Most multi-function-print devices (MFPs) provide several features, such as an option to scan a physical document, which may be controlled via an on-device control panel, a connected application, and/or a remote service. Other options may include printing, copying, faxing, document assembly, etc. The scanning portion of an MFP may comprise an optical assembly located within a sealed enclosure. The sealed enclosure may have a scan window through which the optical assembly can scan a document, which may be placed on a flatbed and/or delivered by a sheet feeder mechanism.

Many MFPs, and other devices such as 3D and/or additive material printers, rely on consumable materials such as printing supplies. For example, a device may use different inks, toners, and/or additive materials. An ink-based printer may utilize four different colors of ink in some situations—cyan, magenta, yellow, and black, often referred to as CMYK colors—to produce color printouts. These colors may each be contained in a different consumable container, such as an ink cartridge, and may be depleted at different rates.

In some implementations, consumables may be shipped for replacement as the consumable containers near the end of their service life. Shipping times may be taken into account to ensure that the printer user is able to continue printing by having resupplies of the consumable containers available when a given supply runs out. In some cases, however, users may replace the containers as soon as they receive replacements, resulting in wasted consumable supplies. For example, if only the black ink cartridge is nearing empty, but a user receives cartridges for all four colors, they may replace all four even though one and/or more of the other colors has a large amount of consumable supply remaining. This amount of supply left in the consumable container when it is replaced may be referred to throughout as wasted supply.

The value of the wasted supply may be calculated, for example, according to a subscription model that charges per print job (e.g., per page and/or per 3D print layer). On a per page model, each printed page may be associated with a cost (e.g., $0.03 per page printed) rather than by an amount of supply used. By tracking how much of each supply is used per page, an average amount of the supply per page can be calculated and factored into estimating how many pages a particular consumable supply will be able to fulfill. The device may then keep track of the amount of supply used each time a consumable container is replaced and thus determine how much supply is remaining at any given time, which may then be used to estimate the remaining number of pages.

For example, a consumable supply may start with 50 mL of magenta ink. A historic average may indicate that the device uses 0.02 mL of magenta ink per page, thus providing an average of 2500 pages over the life of the consumable supply. For a subscription fee of $0.03 per page, this may be evaluated to the supply being valued at 2500 pages *$0.03/4 supply colors, or $18.75. If the supply were replaced when half full, then, it would result in $18.75*0.5, or $9.38 in waste value. It is advantageous not to waste consumable supply from the supplier perspective, but since the consumer is not paying directly for the consumable, they have little motivation to prevent waste. Thus, it may be advantageous not to provide a replacement consumable until the existing consumable supply is near empty and thus minimize the risk of waste.

In some implementations, it is also advantageous to bundle multiple consumable containers into a single shipment in order to save on shipping costs. By factoring in the expected waste of replacing the consumable cartridge, a determination may be made whether or not to bundle such a shipment. For example, if a shipment of a first consumable container (e.g., black ink) is being prepared, and the expected waste cost for a second consumable container (e.g., magenta ink) is less than the cost of a separate shipment of that container, then the second container should be shipped at the same time, since the savings on shipping would exceed the cost of the waste.

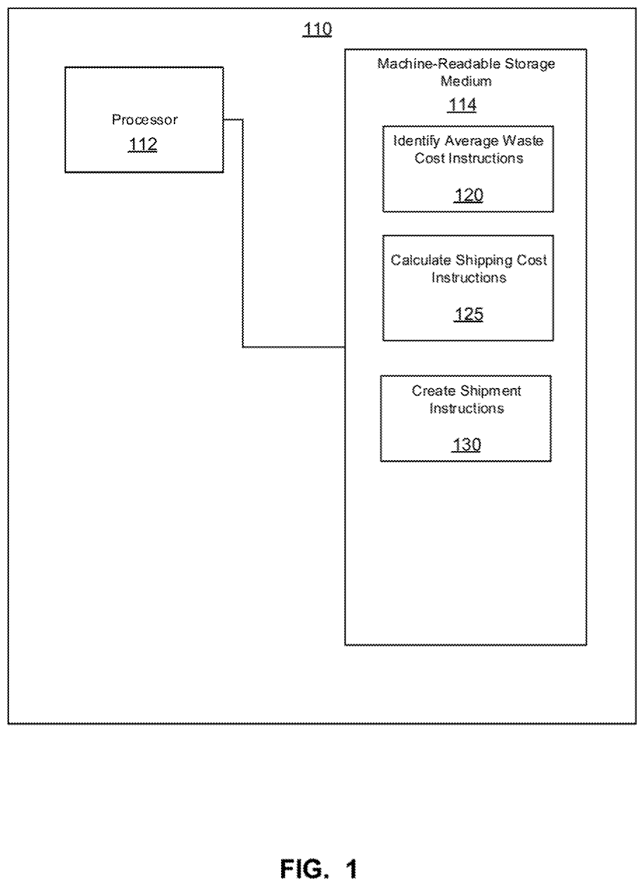

FIG. 1 is a block diagram of an example computing device 110 for providing consumable waste identification. Computing device 110 may comprise a processor 112 and a non-transitory, machine-readable storage medium 114. Storage medium 114 may comprise a plurality of processor-executable instructions, such as identify average waste cost instructions 120, calculate shipping cost instructions 125, and create shipment instructions 130. In some implementations, instructions 120, 125, 130 may be associated with a single computing device 110 and/or may be communicatively coupled among different computing devices such as via a direct connection, bus, or network.

Processor 112 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 114. In particular, processor 112 may fetch, decode, and execute instructions 120, 125, 130.

Executable instructions 120, 125, 130 may comprise logic stored in any portion and/or component of machine-readable storage medium 114 and executable by processor 112. The machine-readable storage medium 114 may comprise both volatile and/or nonvolatile memory and data storage components. Volatile components are those that do not retain data values upon loss of power. Nonvolatile components are those that retain data upon a loss of power.

The machine-readable storage medium 114 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Identify average waste cost instructions 120 may identify an average waste cost for a consumable type. In some implementations, the average waste cost may be calculated according to at least one waste cost associated with an amount of stranded material in the consumable type. For example, the waste cost associated with the amount of stranded material may comprise a value of the amount of stranded material left in the consumable type when it is replaced by a new consumable type. For example, the stranded material may comprise printer ink remaining in a consumable type comprising a print material container such as an ink cartridge when the cartridge is replaced and discarded.

In some implementation, the average waste cost may be calculated for a plurality of discarded consumables of the consumable type. For example, a plurality of consumables may be used by a device across the usable lifetime of the device. For another example, a plurality of consumables may be used by a user across a subscription service period. The value of stranded material in those consumables may be averaged to result in the average waste cost for those consumables.

Calculate shipping cost instructions 125 may calculate a shipping cost for the consumable type and determine whether the shipping cost exceeds the average waste cost. In some implementations, a first consumable of the consumable type may be scheduled for shipment and the average waste cost may be calculated for a second consumable of the consumable type. For example, a printer with four colors of ink may need a shipment of a replacement container of a first color. The average waste cost for one and/or more of the other colors of ink may be calculated. In some implementations, past user behavior such as replacing a container as soon as it is received or waiting until instructed to replace a nearly empty container may be factored in as well. For example, the value of stranded material and thus the average waste cost will be low if the user typically waits even after receiving a replacement consumable.

In some implementations, calculate shipping instructions 125 may identify the lower of a historical average waste of the consumable type and a maximum potential waste for the consumable type. For example, the maximum potential waste may occur if no further amount of the consumable supply is used before a replacement consumable type is received and used to replace the current consumable supply. That is, the maximum potential waste may be considered the value of the supply currently in the consumable type that may be replaced.

Create shipment instructions 130 may create a shipment for the consumable type. In some implementations, the instructions to create the shipment of the consumable type may comprise instructions to bundle the first consumable and the second consumable into a single shipment. For example, if the average waste cost is less than the cost of shipping the second consumable separately, then both consumable types may be bundled into a single shipment. The cost of shipping may be based on the size and/or weight of the consumable type as well as the destination and origin for the shipment.

In response to determining that the shipping cost does not exceed the average waste cost for the second consumable, create shipment instructions 130 may create the shipment only for the first consumable. For example, an order may be placed only for the consumable type that needs refilling and not for any other consumables until those are closer to needing a refill.

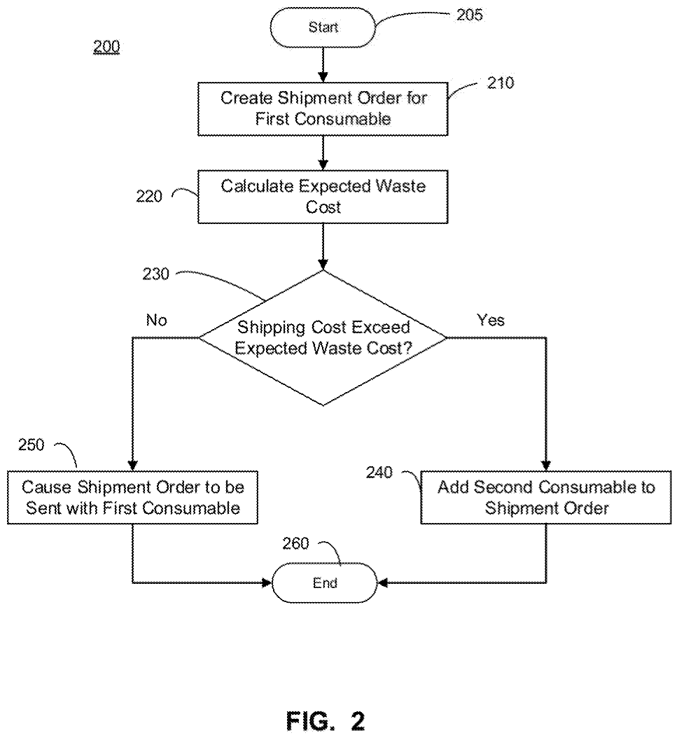

FIG. 2 is a flowchart of an example method 200 for consumable waste identification. Although execution of method 200 is described below with reference to computing device 110, other suitable components for execution of method 200 may be used.

Method 200 may begin at stage 205 and advance to stage 210 where device 110 may create a shipment order comprising a first consumable of a consumable type.

Method 200 may then advance to stage 220 where computing device 110 may calculate an expected waste cost for a second consumable of the consumable type. For example, the expected waste cost may be calculated according to a remaining amount of consumable material in the second consumable of the consumable type. For another example, the expected waste cost may be calculated according to an average amount of discarded consumable material in a plurality of consumables of the consumable type. In some implementations, the expected waste cost may comprise a value of a consumable material left in the second consumable when it is discarded without being used.

Method 200 may then advance to stage 230 where computing device 110 may determine whether a shipping cost for the second consumable exceeds the expected waste cost.

In response to determining that the shipping cost exceeds the expected waste cost, method 200 may advance to stage 240 where computing device 110 may add the second consumable to the shipment order.

In response to determining that the shipping cost does not exceed the expected waste cost, method 200 may advance to stage 240 where computing device 110 may cause the shipment order to be sent with only the first consumable.

Method 200 may then end at stage 250.

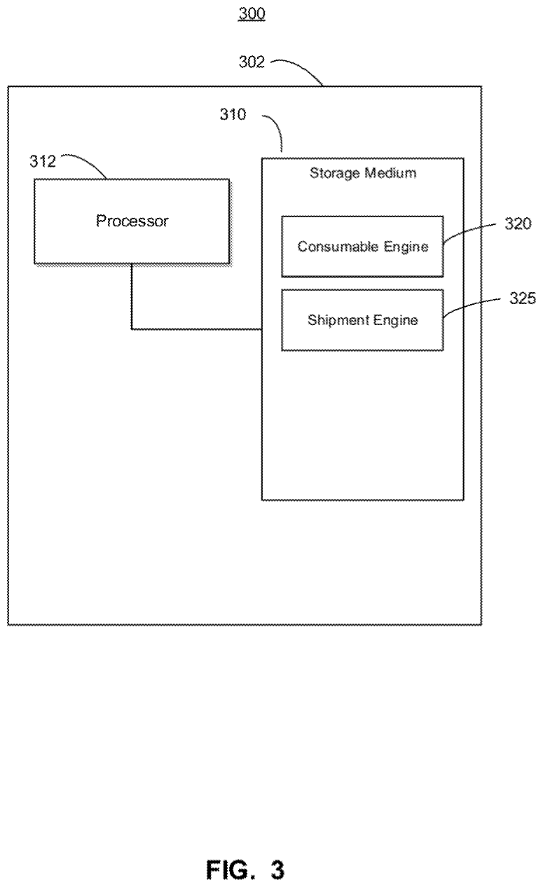

FIG. 3 is a block diagram of an example apparatus 300 for providing consumable waste identification. Apparatus 300 may comprise a multi-function printer device 302 comprising a storage medium 310, and a processor 312. Device 302 may comprise and/or be associated with, for example, a general and/or special purpose computer, server, mainframe, desktop, laptop, tablet, smart phone, game console, printer, multi-function device, and/or any other system capable of providing computing capability consistent with providing the implementations described herein. Device 302 may store, in storage medium 310, a consumable engine 320 and a shipment engine 325.

Each of engines 320, 325 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 320, 325. In such examples, device 302 may comprise the machine-readable storage medium storing the instructions and the processing resource to execute the instructions, or the machine-readable storage medium may be separate but accessible to apparatus 300 and the processing resource.

Consumable engine 320 may detect a first consumable of a consumable type needs replacement and calculate an expected waste cost for a second consumable of the consumable type.

Shipment engine 325 may create a shipment order comprising a first consumable of a consumable type, determine whether a shipping cost for the second consumable exceeds the expected waste cost, and in response to determining that the shipping cost exceeds the expected waste cost, add the second consumable to the shipment order.

In the foregoing detailed description of the disclosure, reference is made to the accompanying drawings that form a part hereof, and in which is shown by way of illustration how examples of the disclosure may be practiced. These examples are described in sufficient detail to allow those of ordinary skill in the art to practice the examples of this disclosure, and it is to be understood that other examples may be utilized and that process, electrical, and/or structural changes may be made without departing from the scope of the present disclosure.

What is claimed:

1. A non-transitory machine readable medium storing instructions executable by a processor to:
identify an average waste cost for a consumable type;
calculate a shipping cost for the consumable type;
determine whether the shipping cost exceeds the average waste cost; and
in response to determining that the shipping cost exceeds the average waste cost, create a shipment for the consumable type.

2. The non-transitory machine readable medium of claim 1, wherein the average waste cost is calculated according to at least one waste cost associated with an amount of stranded material in the consumable type.

3. The non-transitory machine readable medium of claim 2, wherein the at least one waste cost associated with the amount of stranded material comprises a value of the amount of stranded material left in the consumable type when it is replaced by a new consumable type.

4. The non-transitory machine readable medium of claim 3, wherein the consumable type comprises a print material container.

5. The non-transitory machine readable medium of claim 1, wherein the average waste cost is calculated for a plurality of discarded consumables of the consumable type.

6. The non-transitory machine readable medium of claim 1, wherein a first consumable of the consumable type is scheduled for shipment and the average waste cost is calculated for a second consumable of the consumable type.

7. The non-transitory machine readable medium of claim 6, wherein the instructions to create the shipment of the consumable type comprise instructions to bundle the first consumable and the second consumable into a single shipment

8. The non-transitory machine readable medium of claim 7, further comprising:
in response to determining that the shipping cost does not exceed the average waste cost for the second consumable, create the shipment only for the first consumable.

9. The non-transitory machine readable medium of claim 1, wherein the instructions to calculate the shipping cost for the consumable type comprise instructions to identify the lower of a historical average waste of the consumable type and a maximum potential waste for the consumable type.

10. A method comprising:
creating a shipment order comprising a first consumable of a consumable type;
calculating an expected waste cost for a second consumable of the consumable type;
determining whether a shipping cost for the second consumable exceeds the expected waste cost; and
in response to determining that the shipping cost exceeds the expected waste cost, adding the second consumable to the shipment order.

10. The method of claim 10, wherein the expected waste cost is calculated according to a remaining amount of consumable material in the second consumable of the consumable type.

10. The method of claim 10, wherein the expected waste cost is calculated according to an average amount of discarded consumable material in a plurality of consumables of the consumable type.

11. The method of claim 10, furthers comprising, in response to, determining that the shipping cost does not exceed the expected waste cost, causing the shipment order to be sent with only the first consumable.

14. The method of claim 10 wherein the expected waste cost comprises a value of a consumable material left in the second consumable when it is discarded without being used.

15. A system, comprising:
a consumable engine to:
detect a first consumable of a consumable type needs replacement, and
calculate an expected waste cost for a second consumable of the consumable type; and
a shipment engine to:
create a shipment order comprising a first consumable of a consumable type;
determine whether a shipping cost for the second consumable exceeds the expected waste cost, and
in response to determining that the shipping cost exceeds the expected waste cost, add the second consumable to the shipment order.
